(19) United States
(12) Patent Application Publication
(10) Pub. No.: US 2013/0116371 A1
(43) Pub. Date: May 9, 2013

(54) Thermally Conductive and Flame-Retarded Compositions

(71) Applicants: Hyurin Oktavia, Jhongli City (TW); Chin-Huei Yen, Tao-Yuan City (TW)

(72) Inventors: Hyurin Oktavia, Jhongli City (TW); Chin-Huei Yen, Tao-Yuan City (TW)

(73) Assignee: KENNER MATERIAL & SYSTEM CO., LTD., Jhongli City (TW)

(21) Appl. No.: 13/459,404

(22) Filed: Apr. 30, 2012

(30) Foreign Application Priority Data
Nov. 8, 2011 (TW) 100140804

(51) Int. Cl. C08K 3/38; C08K 3/22

(52) U.S. Cl. 524/404; 524/432

(57) ABSTRACT

A composition of thermally conductive flame-retarded plastic comprises of: (A) 5 wt % to 45 wt % of polyolefines; (B) 3 wt % to 25 wt % of thermoplastic elastomer; (C) 35 wt % to 85 wt % of thermal conductive fillers; (D) 5 wt % to 55 wt % of flame retardant additive free of halogen, phosphorus and nitrogen; and (E) 0.5 wt % to 6 wt % of coupling agents. The composition exhibits high surface impedance and meets at least the UL94 V1 rating. The composition has a thermal conductivity greater than 1.0 Watts/m-K, a heat deflection temperature greater than 105° C. Besides, the composition is easy to mold and can be made by the method of injection, extrusion or thermoforming.

### BACKGROUND OF THE INVENTION

(1) Field of the Invention

The present invention relates to a composition of flame-retarded thermally conductive polymer compound.

(2) Description of the Prior Art

When the heat generated from electronic components, circuit boards or diodes is continuously accumulated, it is easy to lead to operation errors of components, parts failure, reduced efficiency and shorten lifetime of equipments. Therefore, how to dissipate heat effectively is very important for the electronic components.

The traditional methods of cooling electronic components usually apply the metal plate material for heat dissipating. Compared to polymer materials, metallic materials cost much and the processing is more difficult. However, the thermal conductivity of polymer is only about 0.1˜0.5 Watts/m-K, which is far below the metal and is a big drawback for the application of polymer materials. In order to make up the deficiency of the thermal conductivity to polymer, many researchers filled the polymer with high-thermal conductivity fillers, such as metal powder, metal oxides, carbon fiber, graphite, artificial diamonds, carbon nanotubes, or inorganic silicon nitride.

For example, the published U.S. patent application No. 20110040007 discloses that thermally-conductive thermoplastic material with thermal conductivity up to 20˜35 Watts/m-K can be made by using metal-coated filler particles, secondary filler particles or combination thereof Another published U.S. patent application No. 006048919 and the Taiwan (Republic of China) patent No. M404994, both disclose to apply metals, metal oxides, and some high-conductivity filler to fill within the resin material for improving thermal conductivity thereof.

Currently, most of the LED lighting devices use aluminum cooling fin or other metal materials for serving as the heat sink. However, metal materials usually have the characteristics such as high density, hard to mold, and electrical conductivity. Therefore, it is necessary to further consider the safety problems about electric shock in application. In order to ensure the safety of electrical appliances, some LED manufacturers use plastic insulation to cover drive components. However, the using of plastic insulation would cost much and cause poor heat dissipation, which results in reducing service-life of drive components.

Accordingly, the present invention develops a thermal conductivity plastic with high surface resistivity, so that the heat generated by the drive components can be dissipated to the thermal-conductivity plastic by direct contact or through the air for promoting the heat-dissipating efficiency of the drive components, thereby to increase the life-time and enhance the safety thereof Furthermore, using only a single material not only can achieve better thermal efficiency, but also can save manpower and resources. The published U.S. patent application No. 20090069483 discloses the using of alumina fibers with particle size of 0.5˜5 μm, compounded with the low resistivity material and thermoplastic resin molded into the insulating resin.

In addition, with the explosion of household appliances continuously occurred, the safety standards of electrical appliances have drawn great attention. For instance, LED lamps and bulbs have the following safety standards: Taiwan CNS 14335, CNS 15436 and CNS15438, North American UL-1993 & UL-8750, Canada CSA1993˜2009, the European IEC/EN 62560 and IEC/EN 60598-1, Korean KSC 7651˜7653. The requirements of these fire safety regulations are more than V1 grade, but the most product in market do not meet the fire safety requirements. Therefore, the development of flame retarded and high surface resistivity thermally-conductive plastic will meet future market demand and be widely used in various components and household appliances.

### SUMMARY OF THE INVENTION

The present invention provides a composition of thermally conductive flame-retarded plastic. The composition of thermally conductive flame-retarded plastic material, includes: A) at least one polyolefin is preferably 5% to 45% by weight of the total composition, and B) at least one thermoplastic elastomer, is preferably 3% to 25% by weight of the total composition, wherein the total weight of the polyolefin and thermoplastic elastomer is preferably 10% to 50% by weight of the total composition, and C) at least one thermally conductive filler is preferably 35% to 85% by weight of the total composition. The thermally conductive filler may consist of metallic materials or non-metallic materials with thermal conductivity greater than 10 Watts/m-K or mixture of them. Thermally conductive filler can be in powder or fiber form or mixture of them, which has particle size or diameter preferably between 1 to 40 μm, and D) at least one flame retardant filler is preferably 5% to 55% by weight of the total composition, the flame retardants are non-phosphorus, non-nitrogen based, non-halogenated flame retardants series, and at least one coupling agent is preferably 0.5% to 6% by weight of the total composition.

The invention provides a thermally conductive flame-retarded plastic which meets at least the UL94 V1 ratings, and has property of low thermal impedance and excellent stability. Furthermore, the composition of plastic has the characteristics of thermal conductivity greater than 1.0 Watts/m-K, heat deflection temperature above 105° C., and high electrical surface resistivity. These characteristics make the composition provided by this invention can achieve excellent performance of heat dissipation and flammability rating. This plastic is suitable for heat sink housing of LED lighting, heat dissipation insulating material for electronic component and encapsulating material for various electronic applications and household appliances.

### DESCRIPTION OF THE PREFERRED EMBODIMENTS

In order to make the purpose above-described, features and advantages of the present invention can be more clearly understood, the following preferred embodiment and tables are provided for the invention of thermally conductive flame-retarded plastic compositions.

The main features of the present invention are the plastic material with excellent thermal conductivity and good flammability rating. The thermally conductive flame-retarded plastic composition provided by the present invention comprises at least the following components.

A). One or more polyolefins can be homopolymers or copolymers. Homopolymers can be polyethylene, polypropylene, polybutylene, polypentene, poly 1-hexene, poly 1-octene, polymethylpentene and so on. Copolymers can be ethylene-vinyl acetate copolymers, ethylene-acrylic copolymers, ethylene-acrylate copolymers, propylene-butene copolymers, propylene-4-methyl-1-pentene copolymers, propylene-cyclo olefin copolymers. Polyolefin is preferably 5% to 45% by weight of the total composition, more preferably 10% to 30% by weight of the total composition.

B). At least one thermoplastic elastomer, can be styrenic block copolymers with a mid-block and end-blocks. The mid-block can be ethylene-butylene or ethylene-propylene. The end-blocks can be polystyrene, such as styrene-ethylene-propylene-styrene block copolymers, styrene-ethylene-butylene-styrene block copolymers, styrene-ethylene-butylene block copolymers, styrene-ethylene-propylene block copolymers, and mixtures. It may also be olefin block copolymers class consists of high crystalline polypropylene as the rigid block and block of non-crystalline polyolefin copolymers as the soft block, such as crystalline olefin-ethylene-butylene-olefin crystalline block copolymers, polypropylene-polyethylene oxide-polypropylene block copolymers, polypropylene-non-crystalline polyolefin-polypropylene block copolymers or double-vinyl copolymer segment and so on. The thermoplastic elastomer is preferably 3% to 25% by weight, more preferably 4% to 15% by weight of the total composition.

C). At least one thermally conductive filler is preferably 35% to 85% by weight of the total composition. The thermally conductive filler can be chosen to be in powder form, fiber form, or mixture of them. More than 90% of the powder or fiber has particle size or diameter preferably between 1˜40 μm. The thermally conductive filler is selected from metallic material, non-metallic material with thermal conductivity value greater than 10 Watts/m-K, or mixture of them.

In one preferred embodiment, the metallic material is selected from the group consisting of silver, aluminum, gold, copper, nickel, zinc, or any combination thereof The non-metallic material with a thermal conductivity value equal to or higher than 10 Watts/m-K, is preferably selected from the group consisting of aluminum nitride, aluminum oxide, beryllium oxide, magnesium oxide, zinc oxide, boron nitride, diamond, graphite, carbon nanotubes, silicon carbide, tungsten carbide, silicon nitride, glass fiber and wollastonite, alone or any mixture thereof

When the thermally conductive filler is a mixture of metallic and non-metallic material, the metallic material is preferably 1% to 80% by weight, more preferably 25% to 60% by weight of the total composition. The non-metallic material is preferably 1% to 70% by weight, more preferably 5% to 55% by weight of the total composition.

When the thermally conductive filler includes only non-metallic material, the thermally conductive filler is preferably 35% to 85% by weight, more preferably 50% to 85% by weight of the total composition.

D). At least one flame retardant filler in a preferred embodiment is selected from non-phosphorus, non-nitrogen based and non-halogenated flame retardants series. Suitable flame retardant filler includes zinc borate, aluminum hydroxide, magnesium hydroxide and the combinations thereof The flame retardant filler is preferably in the range of 5% to 55% by weight, more preferably 20% to 40% by weight of the total composition.

Since the flame retardants series applied in the present invention are non-phosphorus, non-nitrogen based and non-halogenated, it does not produce toxic gases during the combustion, so it will not affect the biological health and environmental safety. In addition, the aluminum hydroxide or magnesium hydroxide added in the flame retardant filler would decompose at high temperature, absorbing a lot amount of heat and release the water of crystallization. Later, the water in the evaporation process will absorb more heat, thereby to reduce the environmental heat and achieve the effects of flame retardancy.

E). At least one coupling agent, preferably is selected from the group consisting of silane, titanate, aluminum zirconate coupling agent or the combinations thereof, or selected from the group consisting of maleic anhydride grafted polypropylene, maleic anhydride grafted ethylene-propylene-diene terpolymer, maleic anhydride grafted styrene-ethylene-butylene-styrene block copolymers, maleic anhydride grafted styrene-ethylene-propylene-styrene block copolymer and the combinations thereof. The coupling agent is preferably 0.5% to 6% by weight, more preferably 1% to 5% by weight of the total composition.

Besides the aforementioned (A), (B), (C), (D) and (E) components, the composition of thermally conductive flame-retarded plastic materials may further be added with common processing aids. The processing aid is selected from the group consisting of plasticizer, slip agents, antioxidants, UV stabilizers, heat stabilizers, dyes, pigments and the combinations thereof.

The total weight of the polyolefin (A) and thermoplastic elastomer (B) is preferably 10% to 50% by weight of the total composition of the material. When the total weight of the polyolefin (A) and thermoplastic elastomer (B) is less than 20% by weight of the total composition material and the amount of the polyolefin (A) is less than that of the thermoplastic elastomer (B), the content of polyolefin (A) is preferably greater than 65% of that of the thermoplastic elastomer (B). Otherwise, it would be difficult to have the content of the thermal conductivity filler (C) up to 70% by weight of the composition material.

The plastic compositions proposed by the present invention, besides having good thermal conductivity and flame retardancy (meeting flammability rating), also has a high surface resistivity. The methods of preparing and processing the thermally conductive flame-retarded plastic are the same as used for thermoplastic material, include injection molding, extrusion, thermoforming and other appropriate processing methods.

Production Methods

In one embodiment, the production method of the thermally conductive flame-retarded plastic comprises the following steps. The materials of composition including (A), (B), (C), (D) and (E), as aforementioned, are fed into a twin screw extruder respectively to perform a melt kneading process to get the composition together.

The thermally conductive flame-retarded plastic material produced by using this method allows wide selection of mold shapes, and appropriate plastic molding equipment.

Molding specimen of the above-mentioned compositions, according to ISO 22007-2 measurement method, have a thermal conductivity (K-value) greater than 1.0 Watts/m-K.

### EXAMPLE

Please refer to Table 1, which illustrates the composition ratio and respective test results of the Example 1 to 13.

TABLE 1
Formulation and properties of example 1 to 13

| | ex. 1 | ex. 2 | ex. 3 | ex. 4 | ex. 5 | ex. 6 | ex. 7 | ex. 8 | ex. 9 | ex. 10 | ex. 11 | ex. 12 | ex. 13 |
|---|---|---|---|---|---|---|---|---|---|---|---|---|---|
| polyolefin | 11 | 11 | 11 | 11 | 13 | 15 | 8.5 | 8.5 | 8.5 | 8.5 | 7 | 8.5 | 8.5 |
| TPE | 4 | 4 | 4 | 4 | 10 | 8 | 6.5 | 6.5 | 6.5 | 6.5 | 10.7 | 6.5 | 6.5 |
| Al | | | | 44.3 | 27.7 | | 56.4 | 51.9 | 49.4 | 41.9 | 50.4 | 51.9 | 51.9 |
| AlN | | | 10 | | | | | | | | | | |
| BN | | | | | | | | | | 10 | | | |
| Al₂O₃ | 5.8 | 46.8 | 3.6 | | 2.9 | 19.7 | | | | | | | |
| ZnO | 46.8 | 5.8 | 38.9 | 5.2 | 19.3 | 32.0 | 6.6 | 6.1 | 6.1 | 6.1 | 5.9 | 6.1 | 6.1 |
| Mg(OH)₂ | 30 | 30 | 30 | 33 | | 25 | 20 | 24.5 | 27 | 24.5 | 24.3 | 22.25 | 18.85 |
| Al(OH)₃ | | | | | 25 | | | | | | | | |
| ZB | | | | | | | | | | | | 2.25 | 5.65 |
| Coupling agent | 2 | 2 | 2 | 2 | 2 | 0.3 | 1.5 | 2 | 2 | 2 | 1.5 | 2 | 2 |
| Thermal conductivity | 2.1 | 1.8 | 2.0 | 3.1 | 1.7 | 1.1 | 3.1 | 2.4 | 2.3 | 2.1 | 2.8 | 2.5 | 2.8 |
| (W/m-K) | | | | | | | | | | | | | |
| MI (200° C.,10 Kg) | ◯ | Δ | Δ | ◯ | ◯ | ◯ | Δ | X | X | X | Δ | X | X |
| Surface resistivity | ◯ | ◯ | ◯ | Δ | ◯ | ◯ | Δ | ◯ | Δ | ◯ | Δ | ◯ | ◯ |
| (Ω/sq) | | | | | | | | | | | | | |
| HDT(° C.) | ◯ | Δ | ◯ | Δ | Δ | Δ | Δ | Δ | Δ | Δ | Δ | Δ | Δ |
| UL94 2.0 mm | V0 | V0 | V0 | V0 | V0 | V2 | V2 | V2 | V2 | V2 | V2 | V2 | V2 |
| Flammability test | | | | | | | | | | | | | |

Table 1 shows the examples with different composition ratio provided in the present invention. Among them, the composition of the polyolefins, thermoplastic elastomer (TPE), aluminum (Al), aluminum nitride (AlN), boron nitride (BN), aluminum oxide (Al₂O₃), zinc oxide (ZnO), magnesium hydroxide (Mg(OH)₂), aluminum hydroxide (Al(OH)₃), zinc borate (ZB) or coupling agents are expressed as weight percent of the total compositions.

In a embodiment, the production methods are carried out by feeding the polyolefins, thermoplastic elastomers, inorganic fillers, flame retardant filler and coupling agents into the hopper, then continue with kneading and granulation process by using the twin-screw extruder. The screw speed was controlled between 150 to 200 rpm. The granular material obtained was then molded into specimens of 40 mm×40 mm×2 mm-thickness using injection molding machine with screw temperature controlled at 210° C. and mold temperature controlled at 90° C.

Measuring Methods:

### Thermal Conductivity

Thermal conductivity was measured by using Hot Disk test according to ISO 22007-2.

### Melt Index

Melt Index (MI) was measured according to ASTM D1238 at 200° C. under 10 kg load. The evaluation criteria are labeled as follows,
◯: MI greater than 5 g/10 min
Δ: MI between 0.5 g/10 min to 5 g/10 min
X: MI less than 0.5 g/10 min

### Surface Resistivity

Surface resistivity was measured by using Surface Resistivity Analyzer according to ASTM D257.

The evaluation criteria are labeled as follows,
◯: greater than 1E+12 Ω/sq
Δ: between 1E+9 Ω/sq to 1E+12 Ω/sq
X: less than 1E+9 Ω/sq

### Heat Deflection Temperature

Heat deflection temperature (HDT) was measured under load pressure of 0.45 MPa according to ASTM D648.

The evaluation criteria are labeled as follows,
◯: Greater than or equal to 120° C.
Δ: between 105° C. to 120° C.
X: between 90° C. to 105° C.

### Flammability Rating

Flammability rating was tested according to UL 94 vertical test method. Take two set samples, each set contained 5 specimens. Before testing, specimens must be preconditioned at temperature 23±2° C. and 50±5% relative humidity for a minimum of 48 hours, and in an air-circulating oven for 168 hours at 70±1° C. and then cooled in the desiccators for at least 4 hours at room temperature, prior to testing. Apply the flame to the central point of the bottom of the specimen so that the top of the burner is below the bottom of the specimen about 10±1 mm. Maintain the spacing of 10±1 mm between the center of the top of the burner and the remaining portion of the specimen, ignoring any strings of molten material. After the application of the flame to the specimen for 10±0.5 seconds, immediately withdraw the burner at a rate of approximately 300 mm/sec, to a distance at least 150 mm away from the specimen and simultaneous commence is measurement of the afterflame time t₁ in seconds and record t₁. As soon as afterflaming of the specimen ceases, immediately place the burner again under the specimen and maintain the burner at a distance of 10±1 mm from the remaining portion of the specimen for an additional 10±0.5 seconds. After this application of the flame to the specimen, immediately remove the burner at a rate of approximately 300 mm/sec, to a distance of at least 150 mm from the specimen and simultaneously commence measurement of the afterflame time, t₂, and the afterglow time, t₃. Record t₂ and t₃. Record whether or not the specimen burned up to the holding clamp and whether or not the specimen drip flaming particles that ignited the cotton indicator. Specifies material was classed as Table 2.

TABLE 2
Material flammability classification

| Criteria conditions | V0 | V1 | V2 |
|---|---|---|---|
| Afterflame time for each individual specimen t₁ or t₂ (s) | 10 | 30 | 30 |
| Total afterflame time for any condition set (t₁ plus t₂ | 50 | 250 | 250 |
| for the 5 specimens) (s) | | | |
| Afterflame plus afterglow time for each individual | 30 | 60 | 60 |
| specimen after the second flame t₂ + t₃(s) | | | |
| Afterflame or afterglow of any specimen up to the | No | No | No |
| holding clamp | | | |
| Cotton indicator ignited by flaming particles or drops | No | No | Yes |

Polyolefin itself has a high surface resistance, but adding thermally conductive fillers may reduce the surface resistance. Therefore, how to adjust the proportion of polyolefin and thermally-conductive fillers to improve thermal conductivity of the plastic composition and at the same time still maintain high surface resistance become one of the technical features in present invention.

All the samples of example 1-13 has Heat deflection temperature (HDT) higher than 105° C., thermal conductivity greater than 1.0 Watts/m-K and surface resistance more than 1E+9 Ω/sq, as shown in the Table 1. The HDT, thermal conductivity and surface resistance of the plastic compositions are in the certain standard, or even better, which means that it can be applied as heat sink-related materials. In addition, the measured melt index at 200° C. under load 10 Kg is above 0.5 g/10 min, provides ease of preparation and processing.

It is worth saying that the more proportion of flame retardants filler added, the compound would has better flammability rating, such as preferred example 1 to 5, wherein have at least UL94 V1 grade. In other words, the composition ratio of the example 1 to 5 not only has good thermal conductivity and high surface resistivity, but also has good flammability rating.

The above test data proves that the compositions of the plastic provided by the present invention have several advantages, such as flame retardancy, high thermal conductivity, and high surface resistance. The material of the present invention can be used as the heat sink material for the electronic components, circuit boards or diode, or used to manufacture the case or housing for the LED lighting devices or household appliances. Also, it is easy to process and manufacture the plastic compositions of the present invention by injection, extrusion or thermoforming.

Although the disclosure of the present invention has been described in the preferred embodiment as aforementioned, but it is not intended to limit the spirit and the scope of the invention to the example given herein. Those who skilled in the art, can easily understand and use other components or ways to have the same effect, therefore, all such modification and equivalents are believed to be within the spirit and scope of the present invention should be considered as the appended claim.

What is claimed is:

1. A composition of thermally conductive flame-retarded plastic comprising:
A. at least one polyolefin, in a range of 5% to 45% by weight of the composition; and
B. at least one thermoplastic elastomer, in a range of 3% to 25% by weight of the composition, wherein the total weight of the polyolefin and the thermoplastic elastomer is between 10% to 50% by weight of the composition; and
C. at least one thermally conductive filler, in a range of 35% to 85% by weight of the composition, being selected from a metallic material, a non-metallic material with a thermal conductivity value greater than 10 Watts/m-K, or a mixture thereof; and
D. at least one flame retardant filler, in a range of 5% to 55% by weight of the composition, being non-phosphorus, non-nitrogen based and non-halogenated; and
E. at least one coupling agent, in a range of 0.5% to 6% by weight of the composition.

2. The thermally conductive flame-retarded composition according to claim 1, wherein when the total weight of the polyolefin and the thermoplastic elastomer is less than 20% by weight of the composition and a content of the polyolefin is less than that of the thermoplastic elastomer, the content of the polyolefin is greater than 65% of that of the thermoplastic elastomer.

3. The thermally conductive flame-retarded composition according to claim 1, wherein the metallic material for the thermally conductive filler is selected from the group consisting of silver, aluminum, gold, copper, nickel, zinc, and a any mixture thereof, the non-metallic material is selected from the group consisting of aluminum nitride, aluminum oxide, beryllium oxide, magnesium oxide, zinc oxide, boron nitride, diamond, graphite, carbon nanotubes, silicon carbide, tungsten carbide, silicon nitride, glass fiber, wollastonite and any mixture thereof.

4. The thermally conductive flame-retarded composition according to claim 1, wherein when the thermally conductive filler is a mixture of the metallic material and the non-metallic material, the metallic material is 1% to 80% by weight of the composition, and the non-metallic material is 1% to 70% by weight of the composition.

5. The thermally conductive flame-retarded composition according to claim 1, wherein when the thermally conductive filler material only consists of the non-metallic material, the non-metallic material is present in the range of 35% to 85% by weight of the composition.

6. The thermally conductive flame-retarded composition according to claim 1, wherein the thermally conductive filler is in powder or fiber form, and more than 90% of the powder or the fiber has a size or a diameter in a range of about 1˜40 μm.

7. The thermally conductive flame-retarded composition according to claim 1, wherein the flame retardant filler is present in a range of 20% to 40% by weight of the composition and is selected from the group consisting of zinc borate, aluminum hydroxide, magnesium hydroxide and any mixture thereof.

8. The thermally conductive flame-retarded composition according to claim 1, wherein the coupling agent is present in the range of 1% to 5% by weight of the composition, and is selected from the group consisting of silane, titanate, aluminum zirconate or any combinations thereof, or selected from the group consisting of maleic anhydride grafted polypropylene, maleic anhydride grafted ethylene propylene diene terpolymer, maleic anhydride grafted styrene-ethylene-butylene-styrene block copolymers, maleic anhydride grafted styrene-ethylene-propylene-styrene block copolymer, or any combination thereof.

9. The thermally conductive flame-retarded composition according to claim 1, having a thermal conductivity greater than 1.0 Watts/m-K, a melt index greater than 0.5 g/10 min, a surface resistance higher than 1E+9 Ω/sq, a heat deflection temperature higher than 105° C. and a flammability rating better than UL94 V1.

10. The thermally conductive flame-retarded composition according to claim 1, includes a common processing aid selected form the group consisting of plasticizer, slip agents, antioxidants, UV stabilizers, heat stabilizers, dyes, pigments and any combination thereof.

11. A plastic composition having surface resistivity greater than 1E+9 Ω/sq, comprising:
A. at least one polyolefin, in a range of 5% to 45% by weight of the composition;
B. at least one thermoplastic elastomer, in a range of 3% to 25% by weight of the composition, wherein a total weight of the polyolefin and the thermoplastic elastomer is between 10% to 50% by weight of the composition; and
C. at least one thermally conductive filler, in a range of 35% to 85% by weight of the composition, the thermally conductive filler is selected from a metallic material, a non-metallic material which has a thermal conductivity greater than 10 Watts/m-K, or a mixture thereof.

12. A method for processing the plastic composition according to claim 1 or claim 11 includes injection molding, extrusion, or thermoforming.
